(19) United States
(12) Patent Application Publication
(10) Pub. No.: US 2024/0152862 A1
(43) Pub. Date: May 9, 2024

(54) INTELLIGENT ITEM MANAGEMENT IN AN INFORMATION PROCESSING SYSTEM

(71) Applicant: Dell Products L.P., Round Rock, TX (US)

(72) Inventors: Ajay Maikhuri, Bangalore (IN); Shibi Panikkar, Bangalore (IN)

(21) Appl. No.: 17/983,042

(22) Filed: Nov. 8, 2022

(51) Int. Cl. G06Q 10/08; G06Q 30/02

(52) U.S. Cl. CPC G06Q 10/087; G06Q 30/0205

(57) ABSTRACT

Automated item management techniques are disclosed. For example, for an item type obtainable from one or more sources and storable as inventory at one of a first site or a second site and based on a first demand forecast, a method computes a discrepancy value for the item type for each of the first site and the second site based on a second demand forecast, wherein the second demand forecast is computed more recently in time than the first demand forecast. The method generates, based on the discrepancy value computed for each of the first site and the second site, a recommendation operation to mitigate the discrepancy value at one or more of the first site and the second site. The method causes the recommendation operation to be executed in order to mitigate the discrepancy value at one or more of the first site and the second site.

### FIELD

The field relates generally to information processing systems, and more particularly to automated item management in such information processing systems.

### BACKGROUND

There are many technical scenarios whereby entities attempt to manage items in their control with a goal of minimizing one or more negative consequences from occurring. In one example, a management scenario may comprise items (e.g., parts or other raw materials) that an original equipment manufacturer (OEM) obtains from one or more sources for use in manufacturing a product or some other equipment ordered by a customer. Typically, the OEM obtains the parts and provides them to their own factory or factories and/or to one or more original design manufacturers (ODMs) or one or more contract manufacturers (CMs) for them to manufacture the equipment for the OEM. Further, the OEM typically attempts to determine how many parts will be needed from the one or more sources, i.e., a demand forecast. Unfortunately, scheduling and shipment management of the parts that the ODM/CM needs to manufacture the equipment can be a significant technical burden.

By way of example only, scheduling and shipment management adds computational burden on the underlying information processing systems that manage inventory with respect to tracking and provisioning items in the inventory. Furthermore, electronic communication networks between information processing systems of the OEM and its partners (e.g., ODMs and CMs) are unnecessarily burdened by extra communication regarding scheduling and shipment issues associated with inventory items. As another consideration, inventory scheduling and shipment issues can place a cost burden on the OEM.

### SUMMARY

Illustrative embodiments provide automated item management techniques comprising one or more machine learning-based decision and recommendation algorithms in an information processing system.

For example, in an illustrative embodiment, for an item type obtainable from one or more sources and storable as inventory at one of a first site or a second site and based on a first demand forecast, a method computes a discrepancy value for the item type for each of the first site and the second site based on a second demand forecast, wherein the second demand forecast is computed more recently in time than the first demand forecast. The method generates, based on the discrepancy value computed for each of the first site and the second site, a recommendation operation to mitigate the discrepancy value at one or more of the first site and the second site. The method then causes the recommendation operation to be executed in order to mitigate the discrepancy value at one or more of the first site and the second site.

Advantageously, one or more illustrative embodiments overcome the above and other technical drawbacks associated with existing inventory item management by considering a near-horizon demand forecast in conjunction with one or more item shipment attributes to generate automated decisions and recommendations using one or more machine learning techniques.

These and other illustrative embodiments include, without limitation, apparatus, systems, methods and computer program products comprising processor-readable storage media.

### BRIEF DESCRIPTION OF THE DRAWINGS

FIG. 1A illustrates a first supply chain in an inventory management environment with which one or more illustrative embodiments can be implemented.

FIG. 1B illustrates a second supply chain in an inventory management environment with which one or more illustrative embodiments can be implemented.

FIG. 2 illustrates a third supply chain in an inventory management environment with which one or more illustrative embodiments can be implemented.

FIG. 3A illustrates a table of a far-horizon demand forecast of an inventory item with respect to multiple suppliers and multiple manufacturing facilities for a use case with which one or more illustrative embodiments can be implemented.

FIG. 3B illustrates a table of a near-horizon demand forecast of an inventory item with respect to multiple suppliers and multiple manufacturing facilities for a use case with which one or more illustrative embodiments can be implemented.

FIG. 4 illustrates a supply chain with an overseas-based shipment portion in an inventory management environment having a far-horizon demand forecast for a use case with which one or more illustrative embodiments can be implemented.

FIG. 5 illustrates a supply chain with an overseas-based shipment portion in an inventory management environment having a near-horizon demand forecast according to one or more illustrative embodiments.

FIG. 6 illustrates a table of a rearranged near-horizon demand forecast of an inventory item with respect to multiple suppliers and multiple manufacturing facilities for a use case according to one or more illustrative embodiments.

FIG. 7 illustrates an information processing system environment comprising an intelligent item inventory management system according to an illustrative embodiment.

FIG. 8 illustrates further details of an information processing system environment comprising an intelligent item inventory management system according to an illustrative embodiment.

FIG. 9 illustrates a demand shaping process flow in an intelligent item inventory management system according to an illustrative embodiment.

FIG. 10 illustrates a cost comparison process flow in an intelligent item inventory management system according to an illustrative embodiment.

FIG. 11 illustrates an intelligent item inventory management methodology according to an illustrative embodiment.

FIG. 12 illustrates an example of a processing platform that may be utilized to implement at least a portion of an information processing system for intelligent item inventory management according to an illustrative embodiment.

### DETAILED DESCRIPTION

Supply chain management in the manufacturing industry typically refers to the process of monitoring and taking actions required for a manufacturer, such as an OEM, to obtain raw materials/parts (i.e., items) from one or more sources (e.g., suppliers or vendors), convert those parts into a finished product (equipment) at one or more manufacturing facilities (sites), and then deliver or otherwise deploy the equipment at a customer location. A goal of supply chain management with respect to the parts is to adequately manage supply and demand, e.g., the supply of the parts (the parts procured or otherwise acquired from vendors, etc.) versus the demand of the parts (e.g., the parts needed to satisfy the manufacturing of equipment ordered by a customer). Management of the parts has been a challenge in the traditional and now modern supply chain processes. As mentioned, when inventory management is inaccurate, there are significant negative technical consequences on the underlying information processing and communication systems of the OEM, as well as an added cost burden on the OEM.

In a typical supply chain management scenario associated with an OEM that sells products to its customers, the OEM works with one or more ODMs to build the products. ODMs are third party partners to the OEM at whose facilities the products are built from raw materials/parts (e.g., items) from suppliers. The OEM strives to keep product costs as low as possible. One of the main contributors to product cost is shipment costs.

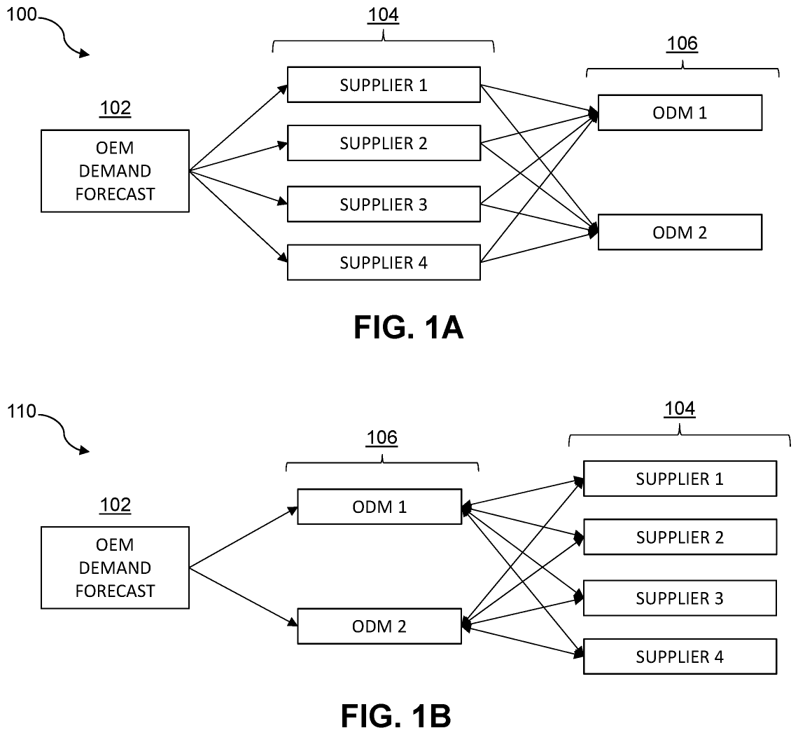

In general, there are typically two processes an OEM can use to get items to ODMs as will be explained in the context of FIGS. 1A and 1B. More particularly, FIG. 1A shows a supply chain process 100 where an OEM demand forecast 102 is used by the OEM to procure items from suppliers 104 (e.g., Supplier 1, Supplier 2, Supplier 3, and Supplier 4), and suppliers 104 then provide the items to ODMs 106 (e.g., ODM 1 and ODM 2). FIG. 1B shows a supply chain process 110 where the OEM demand forecast 102 is used by the OEM to instruct ODMs 106 to procure items from suppliers 104, and suppliers 104 then provide the items to ODMs 106.

It is realized that supply chain process 100 typically gives more control over the supplied items to the OEM as compared with supply chain process 110. That is, while supply chain process 110 is less likely to present technical problems, the OEM has no control over managing the item supply or item quality with supply chain process 110. However, both supply chain processes 100 and 110 face some common technical issues because of the lead time for the shipment from suppliers 104 to ODMs 106. In a supply chain with an ocean-based (i.e., overseas-based) shipment portion, items can take over 30-45 days to reach one or more of ODMs 106. By that time, the demand that was forecasted may have changed, which leads to inaccuracy in the item supply.

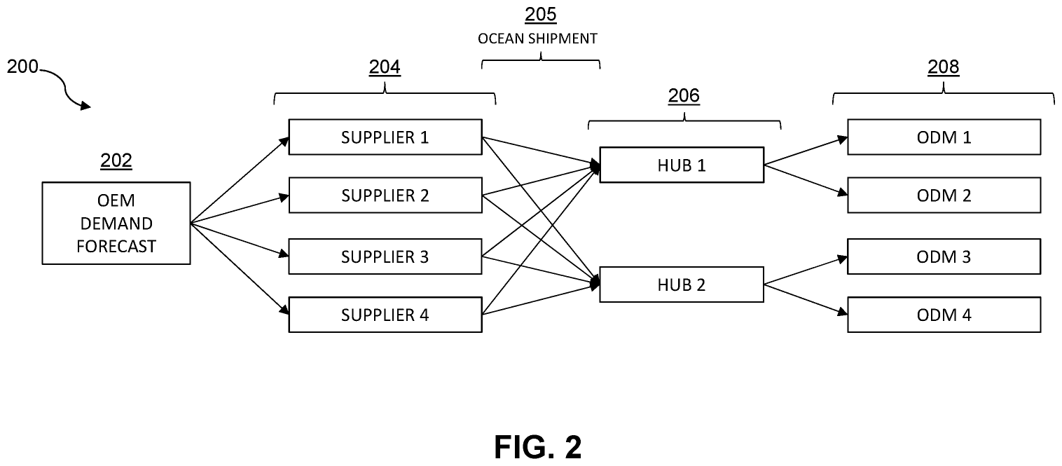

Some OEMs utilize supply chain process 100 with an additional step to further maintain the quality and control the price. This is shown in a supply chain process 200 of FIG. 2. In supply chain process 200, an OEM demand forecast 202 is used by the OEM to procure items from suppliers 204 (e.g., Supplier 1, Supplier 2, Supplier 3, and Supplier 4), and suppliers 204 then provide the items, over an ocean shipment portion 205, to hubs 206 (e.g., HUB 1 and HUB 2). The items are then provided to ODMs 208 (e.g., ODM 1, ODM 2, ODM 3, and ODM 4) from hubs 206.

Further, to maintain the quality of a given type of item used in a product (e.g., a solid state drive used in a storage system), it is realized that an OEM can mandate ODMs 208 to use specific items from specific suppliers 204 as opposed to allowing ODMs 208 to choose the item and suppliers 204 for the given item type.

When the OEM maintains quality and price in this manner, there is overhead for supplying the items to ODMs 208 at the correct time. Typically, the OEM forecasts the demand, and accordingly, the OEM can instruct suppliers 204 to ship the material to ODMs 208. As shown, suppliers 204 supply items to hubs 206 near the port (at the destination of the ocean-based portion of the shipment path) and then the items are delivered (i.e., usually ground-based portion of the shipment path) to ODMs 208. A hub (also referred to singularly herein as hub 206) is considered an intermediate location between the source of the items (e.g., one or more of suppliers 204) and the final destination of the items (e.g., one or more of ODMs 208). This can be referred to as a “trans-shipment.” Trans-shipment is the shipment of goods (i.e., more generally items) or containers with goods therein to an intermediate destination, and then to another destination. One possible reason for trans-shipment is to change the means of transport during the shipment, also known as transloading. In hubs 206, the incoming supply is diverted to the correct ODMs 208 or other manufacturing warehouses near ODM 208 (sometimes referred to as shipper load counts or SLCs). That is, a hub 206 collects the shipments from different suppliers 204 and diverts the containers to different ODMs 208 in that region. These costs can be higher but enable better control of the supply.

There is a common technical issue in these typical supply chain processes. When there is a supply chain between long-distance geographies, there is a longer transit lead time, and the forecast accuracy level is almost always lower if it is too far ahead in time. For example, when ordering items from a geographic location such as China to meet United States (US) demand, the existing supply chain process provides a forward-looking forecast for each ship-to-facility (ODM) in the US while accounting for transit lead-time. However, once the items arrive at the demand geographic location's port or soil, the demand forecast for various ship-to-facilities within a demand geographic location in the US may have changed, resulting in the following issues:
(i) Some facilities (e.g., ODMs 208) will have more inventory but not enough demand to consume it in the near future, resulting in the probability of item aging being greater, which is a loss to the company and a burden on the underlying computing and communication infrastructures. This is mitigated by moving items to another facility which leads to additional shipment and labor costs and more burden on the underlying computing and communication infrastructures.
(ii) Some facilities (e.g., ODMs 208) will have less inventory, resulting in an inability to meet the customer order leading to a poor customer experience and a loss for the company and burden on the underlying computing and communication infrastructures. This is mitigated by procuring items on short notice to meet the customer order, resulting in a revenue loss and a burden on the underlying computing and communication infrastructures.

Today, these situations are handled, after the items reach the ODM as a reactive approach which almost always costs more and puts more burden on the underlying computing and communication infrastructures. In the first of the two supply chain processes described above (e.g., supply chain process 100), the OEM cannot do much as the supplier is directly supplying to the ODM based on a far-horizon forecast (as it can take more than 45 days in ocean shipments). In a variation process (e.g., supply chain process 200), as mentioned above, the OEM gets the supply to a local hub near to the port and diverts the container to a different ODM. Currently, however, a hub is just a distribution center, and there is no process to improve (e.g., optimize) the trans-shipment.

It is realized that many electronic equipment OEMs source materials (items) from various distant geographies or regions in order to achieve a lower material cost. For example, such an OEM uses the far-horizon demand forecast to place an order with a distant supplier to meet the demand of a specific facility (ODM) within the demand region. However, due to the longer transit lead-time required to ship the material from one region to another, the accuracy of the far-horizon demand forecast is reduced. Hence, this introduces inefficiencies, as mentioned above, into the underlying systems.

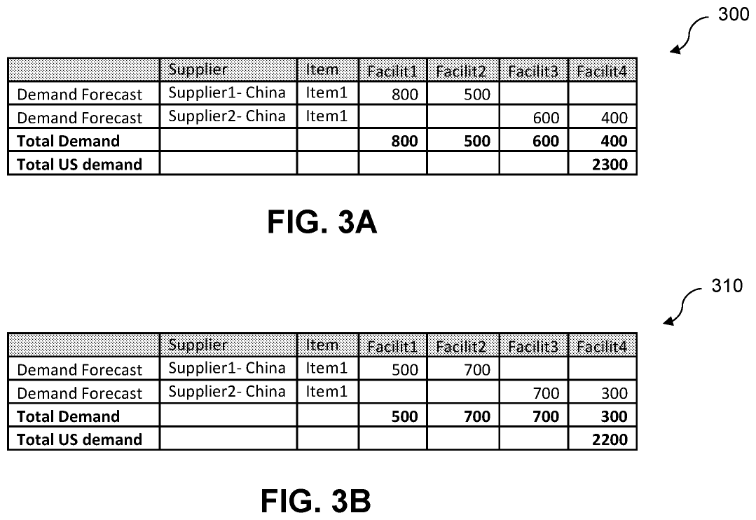

For example, as illustrated in a table 300 of FIG. 3A, assume there are four facilities (e.g., ODMs) in the U.S. (e.g., as shown, Facilit1, Facilit2, Facilit3, and Facilit4), and all of them require a given item, i.e., Item1. Assume further that there are two Chinese suppliers (e.g., as shown, Supplier1-China and Supplier2-China) that supply Item1 and need 45-days transit lead-time to ship the material from China to the U.S. via ocean-based shipment in order to obtain a lower cost (which will lead to a lower cost for the customer of the end product manufactured in the ODMs/facilities). This means that any orders placed with these suppliers will take at least 45 days to arrive at a US port. Assume further that the demand forecast for all of these facilities was created by looking at historical trends and seasonality, and the order specified in table 300 of FIG. 3A was placed with those suppliers with the demand forecast divided into multiple suppliers to avoid risk/monopoly. But when these shipments reach the U.S. port, assume that a near-horizon demand forecast has been changed for each facility as shown in a table 310 of FIG. 3B.

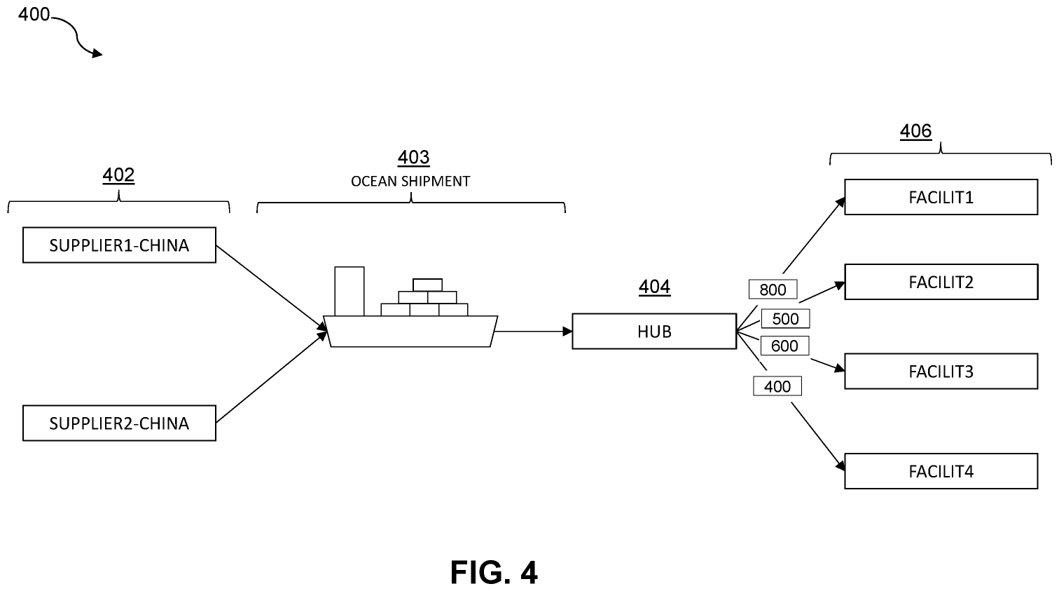

However, in existing approaches, shipping to each facility in the U.S. region is based on the far-horizon demand forecast shown in table 300 of FIG. 3A, and not the more recently updated near-horizon demand forecast of table 310 of FIG. 3B. FIG. 4 illustrates a supply chain process 400 that still uses the far-horizon demand forecast (table 300 of FIG. 3A). As shown, suppliers 402 (Supplier1-China and Supplier2-China) ship Item1 in containers with quantities specified by the far-horizon demand forecast (table 300 of FIG. 3A), via an ocean shipment 403 to a U.S. port with a hub 404. The containers with the far-horizon demand forecast-specified quantities (800, 500, 600, 400) are then ground shipped to ODMs 406 (Facilit1, Facilit2, Facilit3, and Facilit4).

Based on the near-horizon demand forecast of table 310 of FIG. 3B, it can be seen that Facilit2 and Facilit3 are running low on inventory, whereas Facilit1 and Facilit4 are overstocked. As a result, Facilit2 and Facilit3 have two options for meeting the needs of the customer:
(i) Facilit2 and Facilit3 must procure additional inventory from the supplier, but the customer must still wait 45 days for shipment to arrive in the U.S. from China. Furthermore, Facilit1 and Facilit4 have excess inventory that may be aged if not consumed in the near future, contributing to further losses for the OEM.
(ii) Create a material movement request from Facilit1 and Facilit4 as they have excess inventory to Facilit2 and Facilit3, but this will have additional transit lead-time and will incur additional labor and shipment costs.

As a result, the customer experience will suffer in both cases, and the inventory management computing systems of the OEM will be burdened with the extra tasks of implementing one of the two options.

Illustrative embodiments overcome the above and other technical challenges associated with existing inventory management by providing an intelligent item inventory management system in a hub (or otherwise associated with the hub). In one or more illustrative embodiments, intelligent item inventory management system automatically derives recommendations based on all or a subset of a near-horizon forecast (i.e., which is more accurate than a far-horizon forecast as mentioned above), order backlog, large order forecast, MABD (Must Arrived by Date) orders, re-palleting cost, labeling cost, labor cost, ODM to ODM material movement cost, etc. to suggest, which item inventory management option will be more cost-effective and mitigate burden on the underlying information processing systems of the OEM.

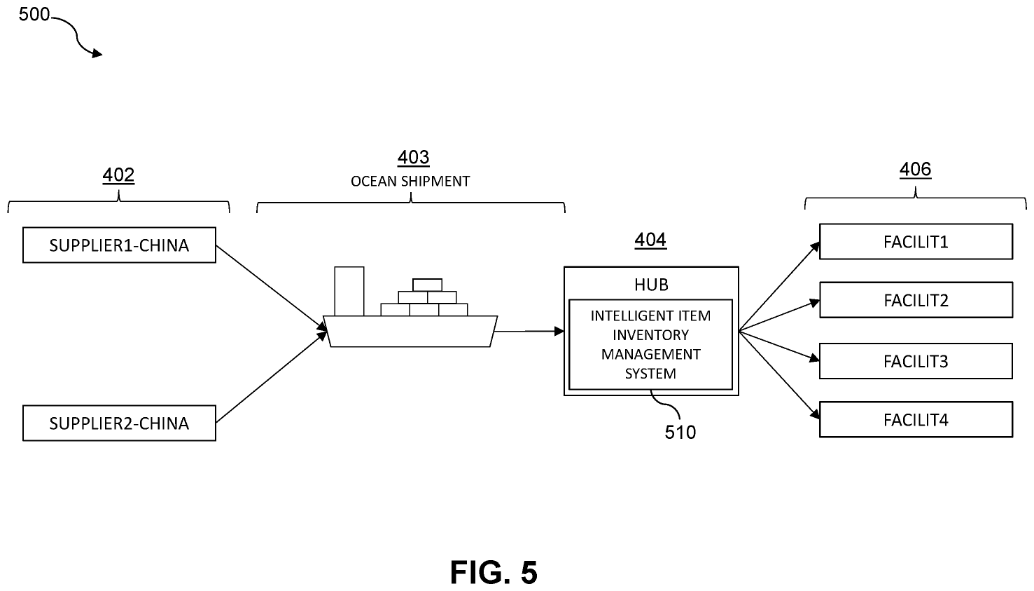

Referring to FIG. 5, a supply chain process 500 utilizing an intelligent item inventory management system 510 improves supply chain process 400 of FIG. 4 by automatically providing recommendations to a supply chain manager with respect to better decisions as to how to manage the containers that were received at hub 404 from suppliers 402. For example, automatically recommended options can include, but are not limited to:
(i) Sending one or more of the containers as is to one or more of ODMS 406 (Facilit1, Facilit2, Facilit3, and Facilit4);
(ii) Splitting a container or merging all or parts of one container with another container, and shipping the containers with adjusted quantities from hub 404 to the ODMS 406 to accommodate for the near-horizon demand forecast.
(iii) Issuing an upfront material movement request to Facilit1 to send part of the material to Facilit2, if Facilit1 has surplus inventory and Facilit2 needs the same part; and
(iv) Issuing a new direct procurement of material to the supplier for a given one of ODMS 406, if there is a shortage in another one of ODMS 406.

These are all proactive measures taken before the material reaches ODMS 406. This can reduce the risk of inventory aging and component shortage issues, which disrupt the supply chain significantly today. The same process can also be utilized for other scenarios, e.g., where material is sourced from long-distance geographic locations.

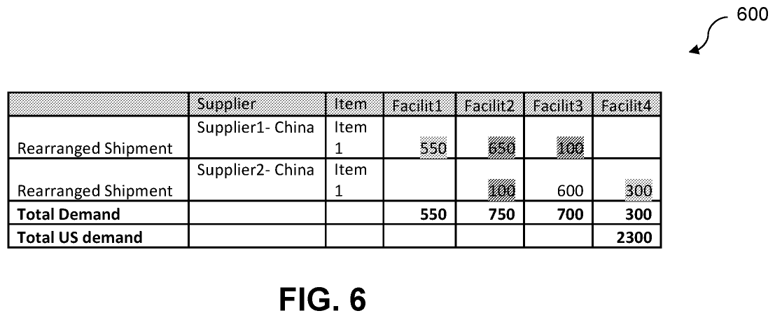

By way of example, as depicted in a table 600 of FIG. 6, intelligent item inventory management system 510 generates recommendations, before shipping to each facility, to split or consolidate the containers (rearranged shipment) when the shipment arrives at the U.S. port hub. As table 600 also shows, intelligent item inventory management system 510 has also adjusted the quantity (100) of excess inventory shipped by the suppliers based on the far-horizon demand forecast.

It is further realized that there can be multiple factors involved in an optimal rearrangement (if needed). For example, material movement from one ODM to another ODM is sometimes more cost-effective than rearrangement at the port or hub, while in other instances, new procurement is more cost-effective. Therefore, in one or more illustrative embodiments, intelligent item inventory management system 510 provides the most cost-effective pro-active rearrangement suggestions to the supply chain manager at the hub.

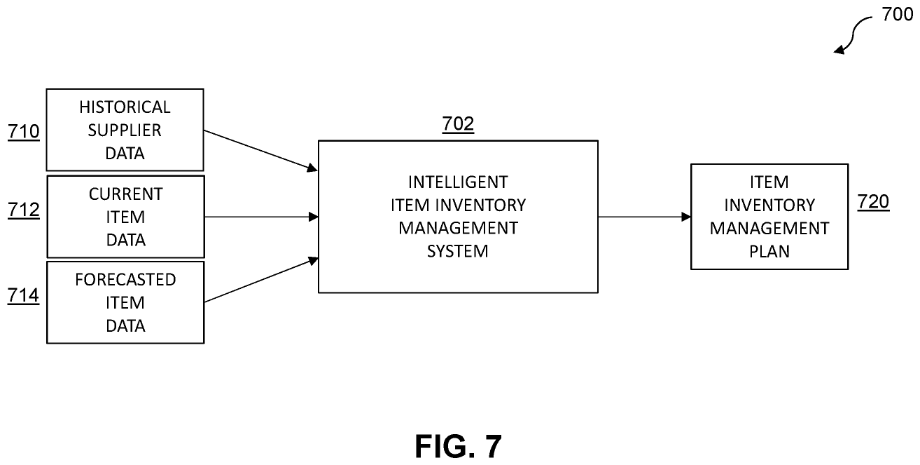

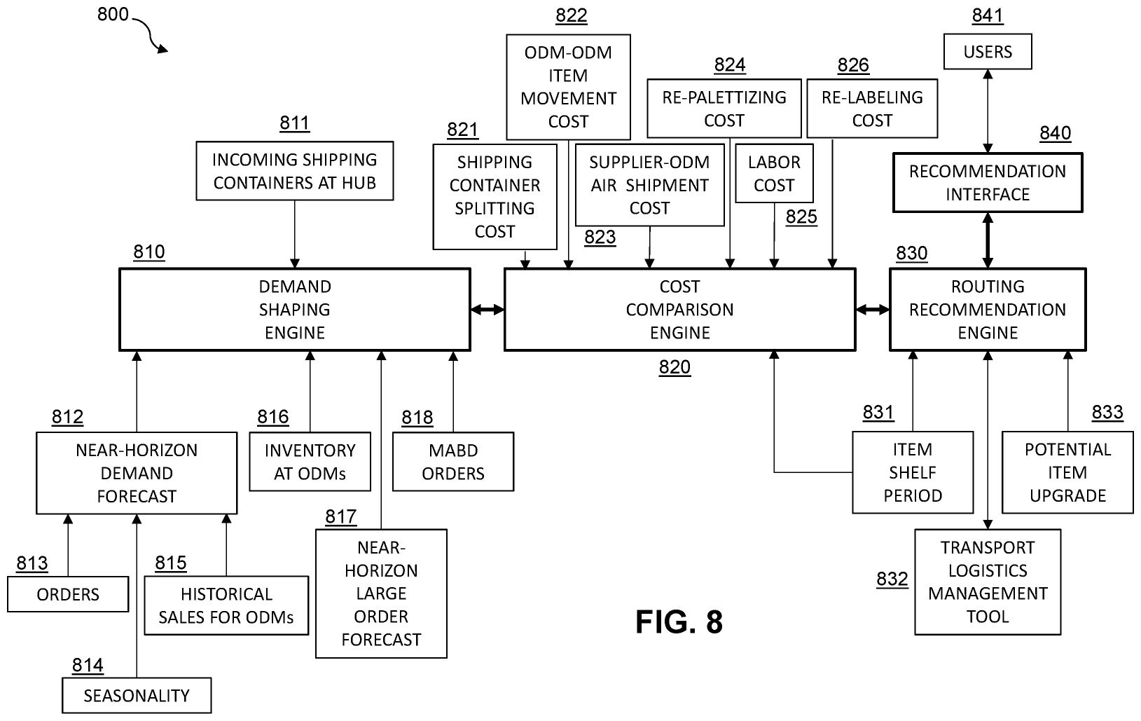

Referring to FIG. 7, an information processing system environment 700 comprising an intelligent item inventory management system according to an illustrative embodiment is shown. More particularly, as shown, an intelligent item inventory management system 702 receives multiple inputs in the form of historical supplier data 710, current item data 712, and forecasted item data 714, and in response to at least a portion of the multiple inputs, generates an item inventory management plan 720. It is to be understood that historical supplier data 710, current item data 712, and forecasted item data 714 are categories of data that will be further explained below in the context of FIG. 8.

FIG. 8 illustrates an intelligent item inventory management system 800 according to an illustrative embodiment. It is to be appreciated that intelligent item inventory management system 800 can be considered an illustrative embodiment of intelligent item inventory management system 702 of FIG. 7.

More particularly, as shown, intelligent item inventory management system 800 comprises a demand shaping engine 810, a cost comparison engine 820, a routing recommendation engine 830, and a recommendation interface 840.

Multiple inputs are provided to demand shaping engine 810 in the form of data 811 representing incoming shipping containers at a given hub, data 812 representing a near-horizon demand forecast, data 813 representing orders (including, backlog orders, recent orders, historical orders, etc.), data 814 representing seasonality, data 815 representing historical sales for ODMS, data 816 representing inventory at ODMS, data 817 representing a near-horizon large order forecast, and data 818 representing MABD orders.

Further, multiple inputs are provided to cost comparison engine 820 in the form of data 821 representing shipping container splitting cost, data 822 representing ODM to ODM item movement cost, data 823 representing supplier to ODM air shipment cost, data 824 representing re-palletizing cost, data 825 representing labor cost, and data 826 representing re-labeling cost. It is to be understood that re-palletizing cost refers to cost associated with breaking open pallets of items from a container and moving some quantity of the items to another pallet so that the other pallet can be put in a container going to another ODM. Re-labeling cost refers to the cost of generating and attaching new identifying labels to the modified pallets and the new pallets.

Still further, multiple inputs are provided to routing recommendation engine 830 in the form of data 831 representing item shelf period, data 832 representing a transport logistics management tool, and data 833 representing potential item upgrade. Item shelf period data 831 indicates how long items of a given type have been at a supplier or other location, while potential item upgrade data 833 indicates a probability that an item of a given type will be upgraded by its manufacturer.

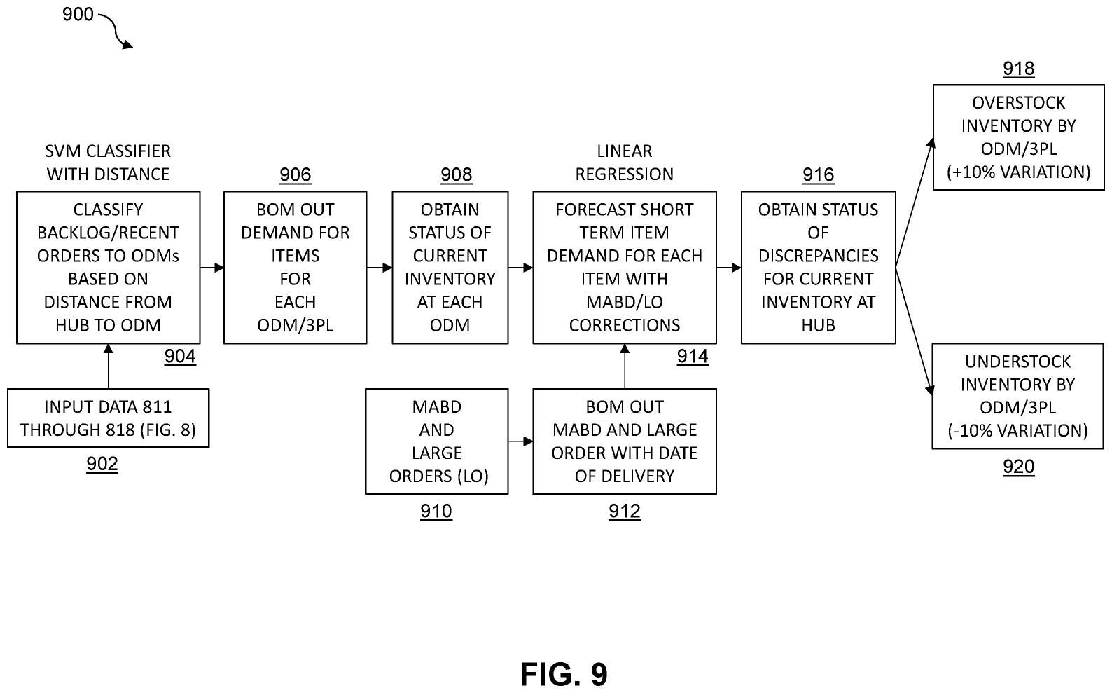

Referring now to FIG. 9, a demand shaping process flow 900 executed by demand shaping engine 810 of FIG. 8 is shown according to an illustrative embodiment. In general, demand shaping engine 810 re-evaluates the supply once it is coming to the hub and determines one or more short-term demand re-shaping options based on real-time variables which will be more accurate than the far-horizon demand forecast, and then sends the computed options to cost comparison engine 820 for executing cost improving (e.g., optimizing) analytics.

More particularly, as shown, demand shaping process flow 900 performs the following steps/operations.

Step 902 receives all or portions of input data 812 through data 818 (FIG. 8).

Step 904 classifies the current backlog based on the region and ODMs/3PL (third party logistics services) around the hub based on distance from the hub. In or more illustrative embodiments, classification can be performed with one or more machine learning algorithms, by way of example, a support vector machine (SVM) algorithm with distant-based metrics. More particularly, in machine learning, SVMs are supervised learning models with associated learning algorithms that analyze data for classification.

Step 906 generates a bill of materials (referred to as BOM out) for the current demand of items for each ODM/3PL.

Step 908 obtains the current inventory at each ODM.

Step 910 obtains MABD orders and large orders for a given short-term time period (e.g., next two weeks), and step 912 generates a bill of materials for these orders based on date of delivery.

Step 914 forecasts the short-term demand for each ODM based on a linear regression-based machine learning algorithm. Since it is short-term, linear regression gives the most accurate result. It is assumed that seasonality data (data 814, if any) is within the short-term time period, and then step 914 also smoothens previous forecast parameters to include seasonality.

Step 916 obtains a discrepancy status for current inventory at the hub for each ODM. More particularly, step 916 computes a difference: (Existing Inventory+Inventory at hub marked for given ODM)−short-term forecasting. Assuming a tolerance level of + or −10% (which is configurable by a user within demand shaping engine 810), inventory is separated into overstock 918 (e.g., >10% going to be overstock) and understock 920 (e.g., <10% going to be understock).

Accordingly, based on demand shaping engine 810, intelligent item inventory management system 800 knows which ODMs/3PLs are going to be overstocked and which ones will be understocked if the original delivery plan (e.g., table 300 of FIG. 3A) remains as is. If there is no ODMs/3PLs that are overstocked or understocked, intelligent item inventory management system 800 recommends sending the containers as per the original delivery plan. However, if there is are ODMs/3PLs that are overstocked or understocked, intelligent item inventory management system 800 analyzes the cost for mitigation via cost comparison engine 820.

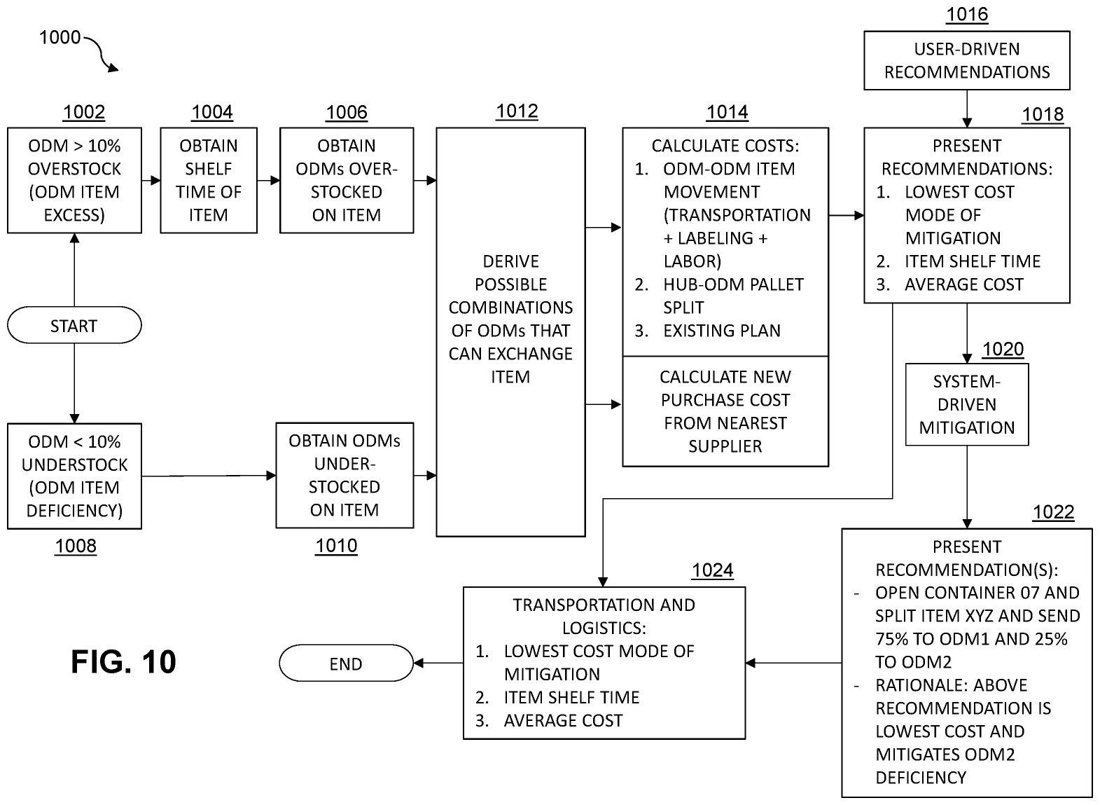

Turning now to FIG. 10, a cost comparison process flow 1000 executed by cost comparison engine 820 of FIG. 8 is shown according to an illustrative embodiment. In general, cost comparison process flow 1000 is based on statistics received from demand shaping engine 810 and cost entries (e.g., all or portions of input data 821 through data 826 of FIG. 8) in different transportation modes and item shelf time.

More particularly, as shown, cost comparison process flow 1000 performs the following steps/operations.

Step 1002 obtains overstock statistics data from cost comparison engine 820.

Step 1004 obtains data identifying shelf time of the given item.

Step 1006 obtains data identifying ODMS that are overstocked on the item.

Step 1008 obtains understock statistics data from cost comparison engine 820.

Step 1010 obtains data identifying ODMS that are understocked on the item.

Step 1012 uses at least a portion of the data obtained in steps 1002 through 1010 to automatically derive possible combinations of ODMS that can exchange items in order to mitigate the overstock/understock conditions.

Step 1014 then receives the possible combinations from step 1012 and calculates costs of: (i) ODM to ODM item movement (e.g., based on cost data such as transportation costs, labeling cost, labor cost) in each combination (note that some combinations can be preconfigured or sourced from SVM distance-based classifications); (ii) average re-palletizing cost (e.g., based on cost data such as labor cost, re-labeling cost); (iii) existing plan cost (e.g., making no change to the delivery plan); and (iv) new item purchase cost from nearest supplier (e.g., based on shelf life of item, i.e., if shelf life is high, then OEM can afford to stock, even if ODM is overstocked).

User-driven recommendations 1016 are input to step 1018 along with costs calculated in step 1014, and step 1018 then presents recommendations including, by way of example only, a lowest cost mode of mitigation, item shelf time statistics, and an average cost for each mitigation option.

These recommendations are then input to a system-driven mitigation in step 1020 which automatically generates a specific mitigation plan. By way of example only, as shown in step 1022, a generated recommendation is presented as opening a given container that was originally destined for an overstocked ODM and splitting the items in the container such that now 75% go to the overstocked ODM and 25% go to an understocked ODM. It is assumed that step 1020 determined that this is the lowest cost re-arranged delivery plan that will mitigate the item deficiency at the understocked ODM.

Recommendations from steps 1018 and 1022 are then sent to transportation and logistics in step 1024 for implementation.

Routing recommendation engine 830 then uses at least a portion of the output of cost comparison engine 820 (mitigation plans/costs) and uses distances between the hub and ODM and supplier, and an indication of potential item upgrade, and then determines the best route along with all mitigation plans.

Recommendation interface 840 enables users 841 (e.g., OEM procurement team) to view different options where the inventory is high/low and take appropriate actions (i.e., accept the recommendations or override them). Once the intelligent item inventory management system 800 is matured (machine learning algorithms iterate to improve their outputs) with respect to the near-horizon forecast accuracy, the recommendation output can be sent to an automated transportation logistics management tool (832) to implement.

Advantageously, as described herein, illustrative embodiments utilize the in-transit hub (trans-shipment) to proactively analyze the discrepancy in the long-term forecast and mitigate the discrepancy using, by way of example, one of the following methods depending on the cost:
(i) Rearrange (split or consolidate shipments) the shipment once it arrives on demand region soil before shipping to each facility based on the most recent demand forecast, inventory position, item shelf time and customer order backlog each facility has, and ship the appropriate number of quantities to each facility.
(ii) Give advance notice to an overstocked ODM/3PL to make necessary arrangements for material movement to an understocked ODM/3PL.
(iii) Proactively place a new order to the nearest supplier to ship the material to an understocked ODM.
(iv) Keep the same original shipment/delivery plan.

These mitigation options provide benefits in the form of reduction in the burden on the underlying computing and communication infrastructures of the OEM, as well as cost benefits.

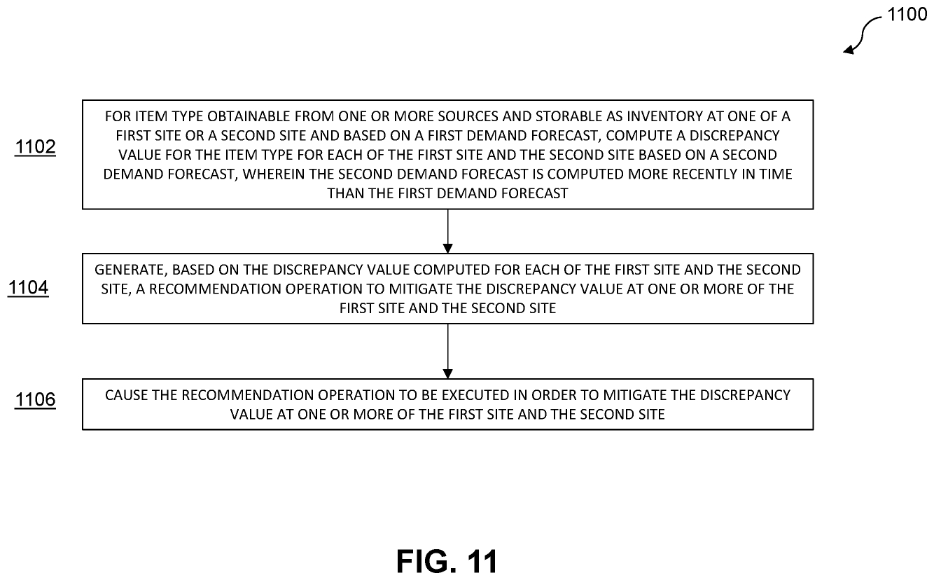

FIG. 11 summarizes an intelligent item inventory management methodology 1100, according to an illustrative embodiment. As shown, for an item type obtainable from one or more sources and storable as inventory at one of a first site or a second site and based on a first demand forecast, step 1102 computes a discrepancy value for the item type for each of the first site and the second site based on a second demand forecast, wherein the second demand forecast is computed more recently in time than the first demand forecast. Step 1104 generates, based on the discrepancy value computed for each of the first site and the second site, a recommendation operation to mitigate the discrepancy value at one or more of the first site and the second site. Step 1106 then causes the recommendation operation to be executed in order to mitigate the discrepancy value at one or more of the first site and the second site.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

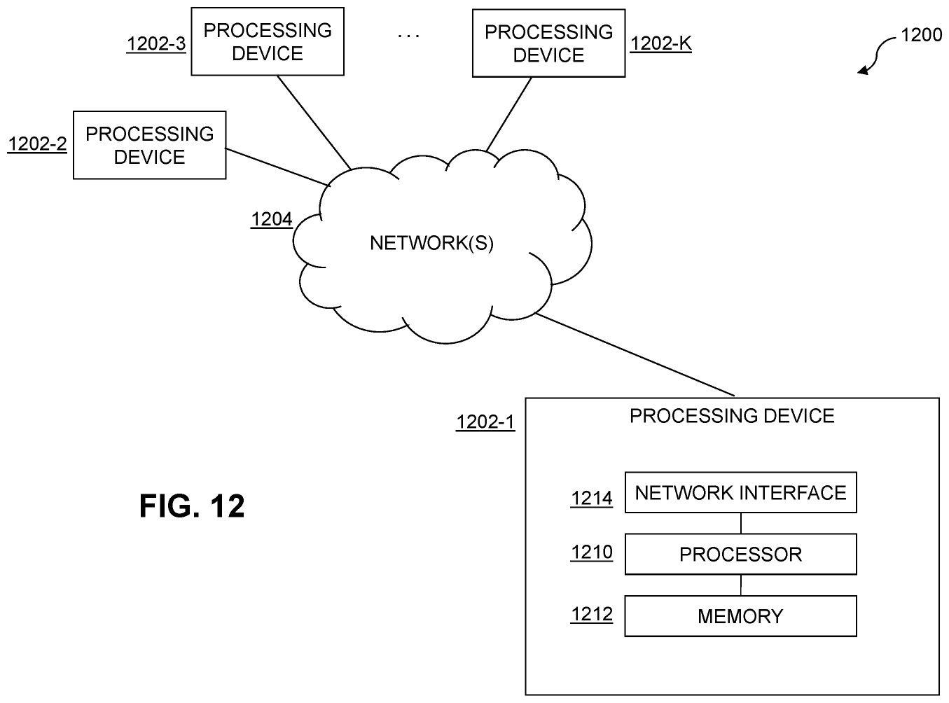

FIG. 12 depicts a processing platform 1200 used to implement systems/processes/data depicted in FIGS. 1 through 11, respectively, according to an illustrative embodiment. More particularly, processing platform 1200 is a processing platform on which a computing environment with functionalities described herein can be implemented.

The processing platform 1200 in this embodiment comprises a plurality of processing devices, denoted 1202-1, 1202-2, 1202-3, . . . 1202-K, which communicate with one another over network(s) 1204. It is to be appreciated that the methodologies described herein may be executed in one such processing device 1202, or executed in a distributed manner across two or more such processing devices 1202. It is to be further appreciated that a server, a client device, a computing device or any other processing platform element may be viewed as an example of what is more generally referred to herein as a “processing device.” As illustrated in FIG. 12, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 1202 shown in FIG. 12. The network(s) 1204 represent one or more communications networks that enable components to communicate and to transfer data therebetween, as well as to perform other functionalities described herein.

The processing device 1202-1 in the processing platform 1200 comprises a processor 1210 coupled to a memory 1212. The processor 1210 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 1210. Memory 1212 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 1212 may comprise electronic memory such as random-access memory (RAM), read-only memory (ROM) or other types of memory, in any combination. The one or more software programs when executed by a processing device such as the processing device 1202-1 causes the device to perform functions associated with one or more of the components/steps of system/methodologies in FIGS. 1 through 11. One skilled in the art would be readily able to implement such software given the teachings provided herein. Other examples of processor-readable storage media embodying embodiments of the invention may include, for example, optical or magnetic disks.

Processing device 1202-1 also includes network interface circuitry 1214, which is used to interface the device with the network(s) 1204 and other system components. Such circuitry may comprise conventional transceivers of a type well known in the art.

The other processing devices 1202 (1202-2, 1202-3, . . . 1202-K) of the processing platform 1200 are assumed to be configured in a manner similar to that shown for computing device 1202-1 in the figure.

The processing platform 1200 shown in FIG. 12 may comprise additional known components such as batch processing systems, parallel processing systems, physical machines, virtual machines, virtual switches, storage volumes, etc. Again, the particular processing platform shown in this figure is presented by way of example only, and the system shown as 1200 in FIG. 12 may include additional or alternative processing platforms, as well as numerous distinct processing platforms in any combination.

Also, numerous other arrangements of servers, clients, computers, storage devices or other components are possible in processing platform 1200. Such components can communicate with other elements of the processing platform 1200 over any type of network, such as a wide area network (WAN), a local area network (LAN), a satellite network, a telephone or cable network, or various portions or combinations of these and other types of networks.

Furthermore, it is to be appreciated that the processing platform 1200 of FIG. 12 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 1200 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-12 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory, the at least one processing device, when executing program code, is configured to:
for an item type obtainable from one or more sources and storable as inventory at one of a first site or a second site and based on a first demand forecast, compute a discrepancy value for the item type for each of the first site and the second site based on a second demand forecast, wherein the second demand forecast is computed more recently in time than the first demand forecast;
generate, based on the discrepancy value computed for each of the first site and the second site, a recommendation operation to mitigate the discrepancy value at one or more of the first site and the second site; and
cause the recommendation operation to be executed in order to mitigate the discrepancy value at one or more of the first site and the second site.

2. The apparatus of claim 1, wherein the discrepancy value computing is executed with one or more machine learning algorithms.

3. The apparatus of claim 2, wherein the one or more machine learning algorithms comprise a supervised distance-based classification algorithm.

4. The apparatus of claim 3, wherein the supervised distance-based classification algorithm classifies a current condition associated with the item type based on respective distances between the first site and the second site with respect to a third site.

5. The apparatus of claim 4, wherein the third site is a receiving hub for respective quantities of the item type designated for the first site and the second site in accordance with the first demand forecast.

6. The apparatus of claim 5, wherein the one or more sources of the item type are geographically distant from the receiving hub.

7. The apparatus of claim 2, wherein the one or more machine learning algorithms comprise a linear regression algorithm.

8. The apparatus of claim 7, wherein the linear regression algorithm adjusts the second demand forecast based on one or more current order types associated with the item type.

9. The apparatus of claim 1, wherein the discrepancy value for each of the first site and the second site indicates whether, based on the second demand forecast, the first site and the second site have an overstock condition with respect to the item type or an understock condition with respect to the item type.

10. The apparatus of claim 9, wherein the recommendation operation to be executed in order to mitigate the discrepancy value at one or more of the first site and the second site comprises one or more actions to mitigate at least one of the overstock condition and the understock condition.

11. The apparatus of claim 1, wherein generating the recommendation operation further comprises utilizing cost data to determine a set of mitigation plans from which the recommendation operation is selectable.

12. The apparatus of claim 11, wherein the cost data comprises data representing one or more of item movement cost, item handling cost, and labor cost associated with implementing the set of mitigation plans.

13. The apparatus of claim 11, wherein the recommendation operation is selected from the set of mitigation plans based on a lowest cost condition.

14. The apparatus of claim 1, wherein the item type is a part type used in a manufacturing process of a product by an entity responsible for the first demand forecast and the second demand forecast.

15. The apparatus of claim 14, wherein the first site and the second site are facilities at which the manufacturing process of the product is performed.

16. The apparatus of claim 1, wherein the first demand forecast comprises a far-horizon demand forecast and the second demand forecast comprises a near-horizon demand forecast.

17. A method comprising:
for an item type obtainable from one or more sources and storable as inventory at one of a first site or a second site and based on a first demand forecast, computing a discrepancy value for the item type for each of the first site and the second site based on a second demand forecast, wherein the second demand forecast is computed more recently in time than the first demand forecast;
generating, based on the discrepancy value computed for each of the first site and the second site, a recommendation operation to mitigate the discrepancy value at one or more of the first site and the second site; and
causing the recommendation operation to be executed in order to mitigate the discrepancy value at one or more of the first site and the second site;
wherein the computing, generating, and causing steps are performed by at least one processing device executing program code.

18. The method of claim 17, wherein the discrepancy value computing is executed with one or more machine learning algorithms.

19. A computer program product comprising a non-transitory processor-readable storage medium having stored therein program code of one or more software programs, wherein the program code when executed by at least one processing device cause the at least one processing device to:
for an item type obtainable from one or more sources and storable as inventory at one of a first site or a second site and based on a first demand forecast, compute a discrepancy value for the item type for each of the first site and the second site based on a second demand forecast, wherein the second demand forecast is computed more recently in time than the first demand forecast;
generate, based on the discrepancy value computed for each of the first site and the second site, a recommendation operation to mitigate the discrepancy value at one or more of the first site and the second site; and
cause the recommendation operation to be executed in order to mitigate the discrepancy value at one or more of the first site and the second site.

20. The computer program product of claim 19, wherein the discrepancy value computing is executed with one or more machine learning algorithms.
